(19) United States
(12) Patent Application Publication
(10) Pub. No.: US 2017/0170739 A1
(43) Pub. Date: Jun. 15, 2017

(54) SOLAR POWER CONVERTER WITH ISOLATED BIPOLAR FULL-BRIDGE RESONANT CIRCUIT

(71) Applicant: National Chung-Shan Institute of Science & Technology, Taoyuan City (TW)

(72) Inventors: Hsuang-Chang Chiang, Taipei City (TW); Kun-Feng Chen, Taoyuan City (TW); Ke-Chih Liu, Hsinchu (TW); Chin-Chieh Chang, Taoyuan City (TW)

(21) Appl. No.: 14/965,906

(22) Filed: Dec. 11, 2015

(51) Int. Cl. H02M 3/335

(52) U.S. Cl. CPC H02M 3/33546

(57) ABSTRACT

The present invention provides a solar power converter with isolated bipolar full-bridge resonant circuit. This solar power converter system of the present invention have isolated two-stage full-bridge resonant circuit having a full-bridge resonant converter unit for solar power converter among fixed by uncontrolled phase shift controlled full bridge resonant converter unit, so as to all power switches of the full bridge resonant converter unit in any load can reach zero voltage switching, not only can improve light-load efficiency, the scope for efficiency under full load variation of both improvement and helpful.

### BACKGROUND OF THE INVENTION

1. Field of the Invention

The present invention relates to the technology field of power electronic circuits, and more particularly to a solar power converter with isolated bipolar full-bridge resonant circuit.

2. Description of the Prior Art

Along with evolution and development of solar panels, the amount of sunlight and sunshine different angle affects solar panels generating capacity. Therefore, the circuit designer trying to develop a variety of isolated solar Power Converters to correspond used in different power solar panels.

The isolation solar power converter stage frost resonant circuit having a wide range of applications, circuit designers department actively trying to adjust the float voltage generated by the solar panels and can be used in case of low pressure inputted. The more common approach is, the circuit designer architecture system using non-isolated or isolated architecture, thereby reducing the float voltage generated by the solar panels.

Please refer to FIG. 1A and FIG. 1B, wherein the FIG. 1A illustrates a circuit chart view of a conventional non-isolated buck solar power converter, and the FIG. 1B is illustrates a circuit chart view of a conventional Non-isolated buck-boost solar power converter. Because the Buck solar power converter system comprising: a solar cell module 2′, the buck power conversion unit 12′, and an energy storage unit 13′, wherein the step-down power converter unit 12′ is coupled inputs in the solar cell module 2′, the buck power conversion unit 12′ of the output terminal is coupled to the storage unit 13′. Mainly the use of step-down power conversion unit 12′, one of the inductor 121′ and a capacitor 122′of the low-pass filter filtering the harmonic components of the composition of a high pressure show by FIG. 1A,so that the input voltage of the converter can. However, the disadvantage is that the input voltage is limited by the current of the high voltage variable input voltage.

The buck conventional solar power converter system comprising: a solar cell module 2′, the buck power conversion unit 12′, boost power conversion unit 14′, and an energy storage unit 13′, wherein the buck power conversion unit 12′of the input is coupled to the solar cell module 2′, the buck power conversion unit 12′is coupled to the output of the boost power conversion unit 14′ input. Also, the boost power conversion unit 14′of the output terminal is coupled to the storage unit 13′. Mainly the use of boost power conversion unit 14′and the buck power conversion unit 12′, which makes the high voltage input of the converter is not limited to the varying input voltage, but the disadvantage is the need for more switches, control more complex The circuit cost is higher. Therefore, both the buck or buck-boost circuit in the high voltage of the circuit designs of the need for higher leakage current, in order to ensure their safety.

Because, the isolated power converter circuit is more selective, the circuit may be implemented using a single-stage or a two-stage, although the single-stage circuit to achieve a low cost circuit, but the circuit may have quite different properties under high and low voltage input, select the switching element of the more difficult, and the components may need to withstand high pressures. Dual-stage circuit more flexible, able to cope with broader range of input voltage, the disadvantage is to control more complex, higher circuit cost.

Please refer to FIG. 2A, FIG. 2B, FIG. 2C, wherein the FIG. 2A is illustrates a circuit chart view of a single-stage active clamp forward solar-power converter, and the FIG. 2B and FIG. 2C are illustrates a circuit chart view of a conventional solar power single-stage half-bridge converter and a conventional solar power single-stage full-bridge converter, wherein single-stage active-clamp forward converters solar power system comprising: a solar cell module 2′, the buck power conversion unit 12′, the storage unit 13′, the clamp circuit 15′, and an isolation transformer 16′, which the clamp circuit 15′of the input is coupled to the solar cell module 2′, the clamp circuit 15′is coupled to the output of the isolation transformer 16′ of the input, and the isolation transformer 16′output of the system coupled to the step-down power converter unit 12′ input. Further, the buck power conversion unit 12′of the output terminal is coupled to the storage unit 13′.

The Single-stage half-bridge power converter system comprises a solar: solar cell module 2′, the storage unit 13′, an isolation transformer 16′, half-bridge circuit 17′, and a rectifier 18′, wherein the half-bridge circuit 17 the output of the department inputs lines coupled to the solar cell module 2′, the half-bridge circuit 17′output of the system is coupled to the isolation transformer 16′ of the input, and the isolation transformer 16′coupled to the rectifier 18′is input. Furthermore, the rectifier 18′of the output terminal is coupled to the storage unit 13′.

The Single-stage full-bridge-based solar power converter comprising: a solar cell module 2′, the storage unit 13′, an isolation transformer 16′, the full bridge circuit 19′, and a rectifier 18′, wherein the full bridge circuit 19′ the output of the department inputs lines coupled to the solar cell module 2′, the full bridge circuit 19′is coupled to the output of the isolation transformer 16′ of the input, and the isolation transformer 16′coupled to the rectifier 18′is input. Furthermore, the rectifier 18′of the output terminal is coupled to the storage unit 13′.

In summary, the single-scale solar power converter circuit architecture is the use of the floating range of the input voltage, the transformer turns ratio of the design needs to use the lowest voltage, while at high input voltage, then use to adjust the duty cycle of the way. Therefore, variation in high and low duty cycle.

In addition, the dual-stage circuit architecture is the input side of a single-stage circuit plus a boost of power conversion unit 14′are designed. Please continue to refer to FIG. 3A and 3B; wherein the FIG. 3A is a conventional two-stage boost isolation SRC (series resonance) Solar power converter circuit architecture diagram, the FIG. 3B is a conventional isolation system of Two-stage boost converter LLC Solar power circuit architecture diagram. In FIG. 3A, a conventional two-stage isolator SRC (series resonant) solar power converter system comprising: a solar cell module 2′, the storage unit 13′, the boosting power converter unit 14′, an isolation transformer 16′, SRC (series resonance) half-bridge circuit 17a′, and a rectifier 18′, wherein, the SRC (series resonance) half-bridge circuit 17a′ through the input lines of the boost power converter unit 14′which is coupled to the based solar cell module output terminal 2′, the SRC (series resonance) half-bridge circuit 17a′ of the output terminal is coupled to the isolation transformer 16′of the input, and the isolation transformer 16′ coupled to the rectifier 18′input. Furthermore, the rectifier 18′of the output terminal is coupled to the storage unit 13′.

Also, as shown in FIG. 3B, a conventional two-stage isolation LLC solar power converter system comprising: a solar cell module 2′, the storage unit 13′, boost power conversion unit 14′, the isolation transformer 16′, LLC half-bridge circuit 17b′, and a rectifier 18′, wherein the LLC half-bridge circuit 17b′ through the input lines of the boost power converter unit 14′which is coupled to the solar cell module 2′, the LLC half-bridge circuit 17b′of the output terminal is coupled to the isolation transformer 16′ of the input, and the isolation transformer 16′is coupled to the output of the rectifier 18′ is input. Furthermore, the rectifier 18′of the output terminal is coupled to the storage unit 13′.

In summary, the Isolation dual-stage solar power converter circuit architecture mainly by adjusting the boost converter such that the second stage isolated circuit output voltage to the input of small changes, so using half-bridge resonant circuit (LLC Resonant Half Bridge Converter) to improve efficiency.

Accordingly, The circuit architecture of the non-isolated and isolated circuit architecture, although widely used in solar power converter; however, conventional non-isolated power converter with isolated solar power converter still has the major drawback of the following:

(1) The non-isolated solar power converter in order to improve the electrical safety of non-isolated solar power converter circuits, usually isolated to the two-stage solar power converter to increase electrical safety; however, the use of isolated conventional two-stage solar power converter, its high and low duty cycle required to control vary widely, resulting in poor system performance, efficiency and stability.

(2) The conventional isolated two-stage solar power converter, a second stage circuit if using resonant circuits, we need to make frequency control. However, although the second-stage circuit can be used full-bridge circuit, and the use of fixed-frequency PWM control of the phase shift circuit improved, but full-bridge circuit at light load is not easy to enter the zero-voltage switching, resulting in poor conversion efficiency.

Accordingly, in view of the Isolated solar power converter system to appear on the practical application of many defects, the case of the invention, the inventors tried to be studied, and finally developed the one of the present invention have isolated two-stage full-bridge resonant circuit of a solar power converter.

### SUMMARY OF THE INVENTION

The primary objective of the present invention is to provide an isolation bipolar full-bridge resonant circuit solar power converter. The proposed two-stage of the present invention is a solar power converter architecture has isolated two-stage full-bridge resonant circuit, which is the first stage may be a boost or will buck converter and having to perform maximum power point tracking (MMPT) the ability to control the second stage is used full-bridge resonant converter, its output voltage to stabilize and improve the overall efficiency.

Accordingly, in order to achieve the primary objective of the present invention, the inventor of the present invention provides a solar power converter with isolated bipolar full-bridge resonant circuit comprises:

a first stage module, coupled to an external solar module to retrieve one of the outer solar module power, wherein the first-stage circuit module according to the capture of the power supply and output a maximum power supply;
a first stage module, comprises:

a filtering unit, comprises:
an Inductor, one end of which is coupled to the first-stage circuit module , which for receiving and storing the current;
a capacitor, the high-pressure side of the other end of the inductor, and the low voltage terminal is coupled to the first-stage circuit module, which for receiving and storing the current in turn generates a voltage;
a full-bridge resonant converter unit, coupled to the capacitor, and the voltage of a rectification process execution;
a transforming unit, coupled to the full-bridge resonant converter unit, and a voltage conversion processing is performed to the voltage conversion process, thereby outputting a second voltage; and
a rectifying unit, coupled to the transforming unit, for receiving the output of the transformer unit of the second voltage, and performs a rectifying processing on the second voltage, and then outputs a DC;
   Wherein, when the solar module of the current source changes, the amount of change of the current source will be the first stage filtering circuit module, in the same time, the first-stage module 1 will maintain the output circuit of the current original.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1A shows a circuit chart view of a conventional non-isolated buck solar power converter;

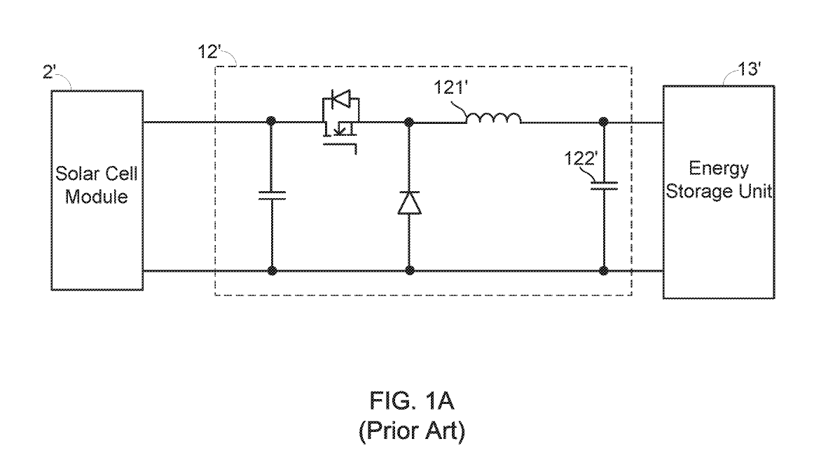

FIG. 1B shows a circuit chart view of a conventional Non-isolated buck-boost solar power converter;

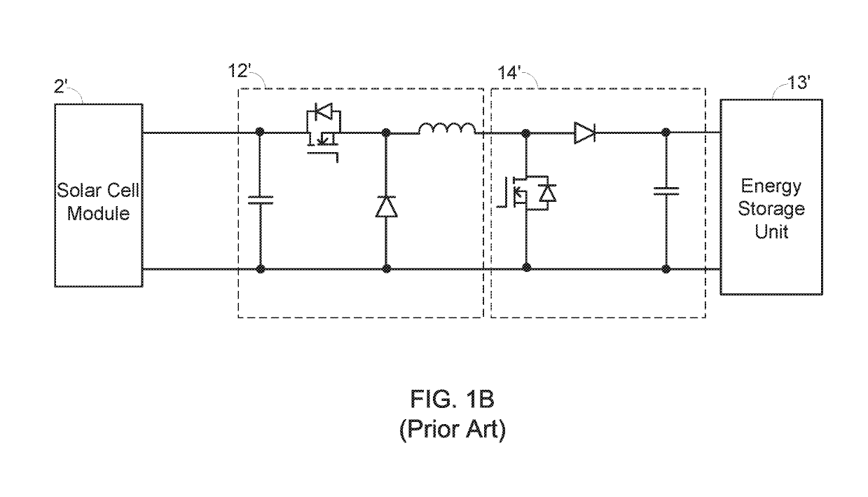

FIG. 2A shows a circuit chart view of a single-stage active clamp forward solar-power converter;

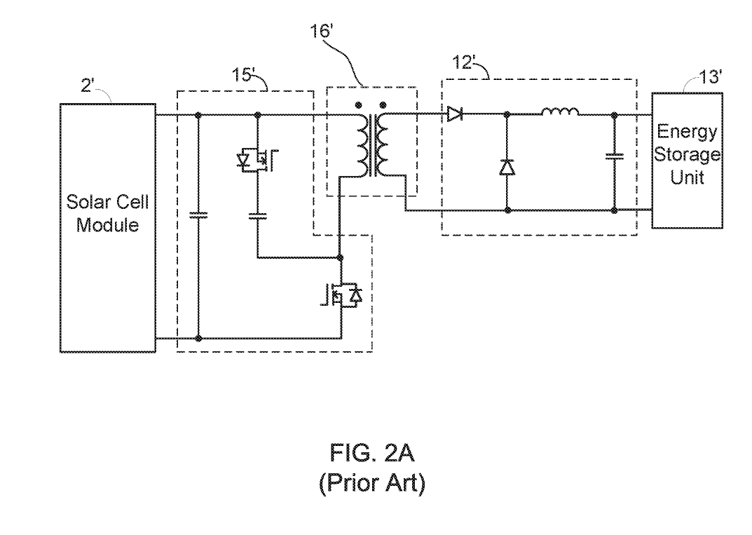

FIG. 2B shows a circuit chart view of a conventional solar power single-stage half-bridge converter;

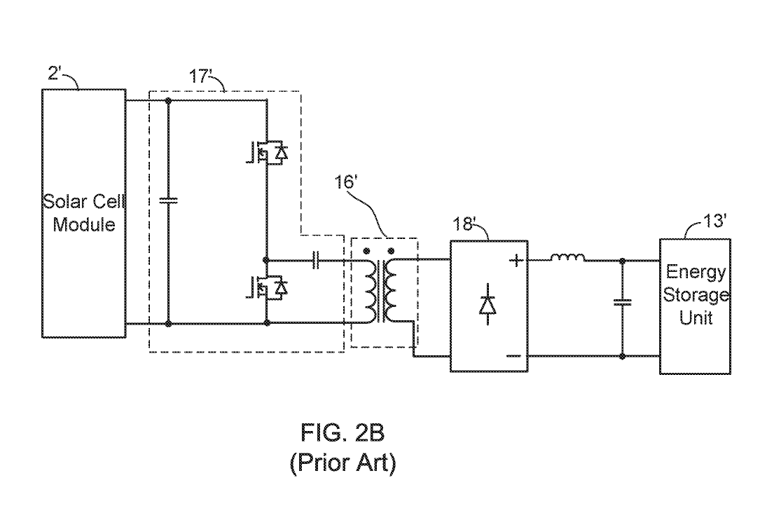

FIG. 2C shows a circuit chart view of a conventional solar power single-stage full-bridge converter;

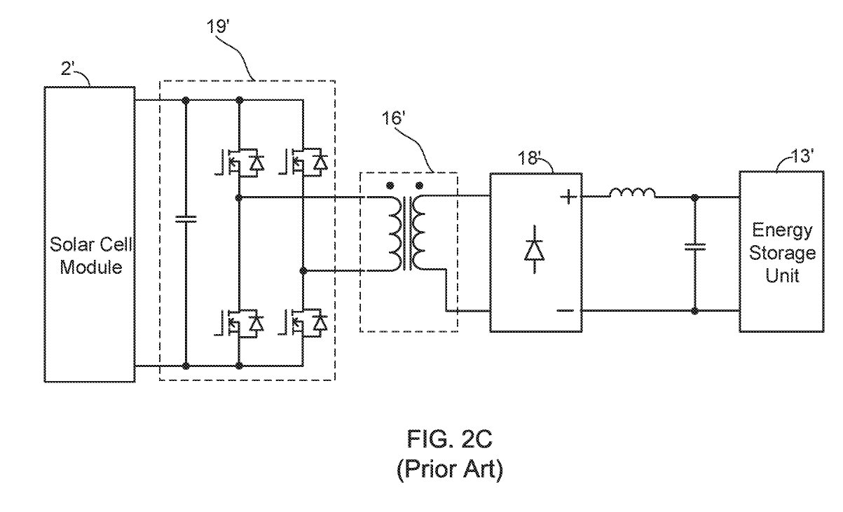

FIG. 3A shows a circuit chart view of a conventional two-stage boost isolation SRC (series resonance) solar power converter circuit architecture diagram;

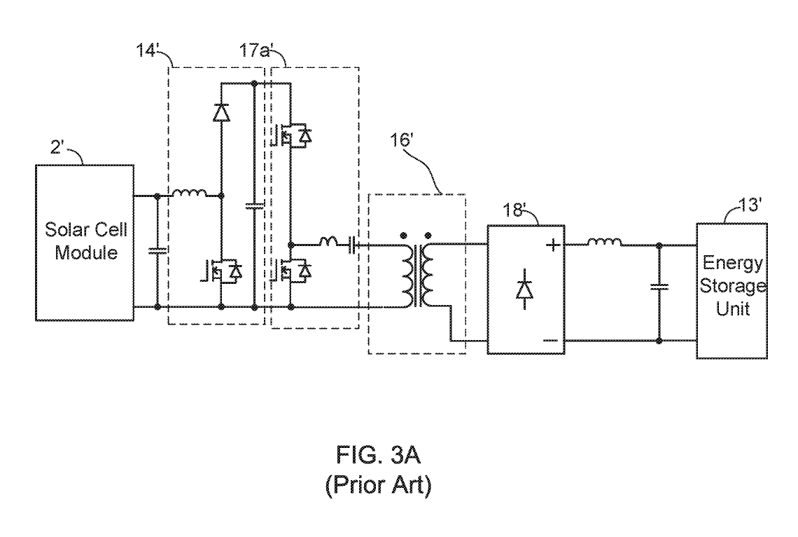

FIG. 3B shows a circuit chart view of a conventional isolation system of Two-stage boost converter LLC Solar power circuit architecture diagram;

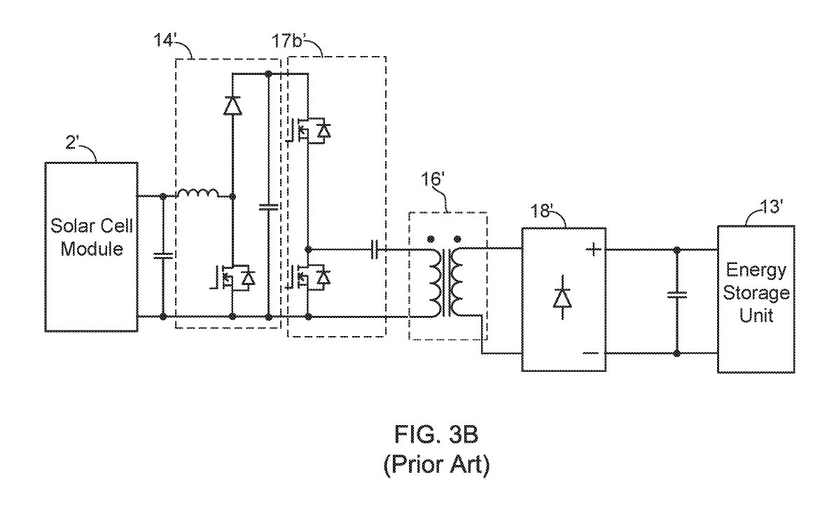

FIG. 4A shows a solar power converter with isolated bipolar full-bridge resonant circuit architecture diagram;

FIG. 4B shows a solar power converter with isolated bipolar full-bridge resonant circuits;

FIG. 5 shows a solar power converter of the present invention having an isolated two-stage full-bridge resonant circuit simulation waveform;

FIG. 6 shows a PV start and variable load of an analog waveform diagram; and

FIG. 7 shows at full load simulation waveform diagram of each part of the isolated bipolar full-bridge resonant converter solar power.

### DETAILED DESCRIPTION OF THE PREFERRED EMBODIMENTS

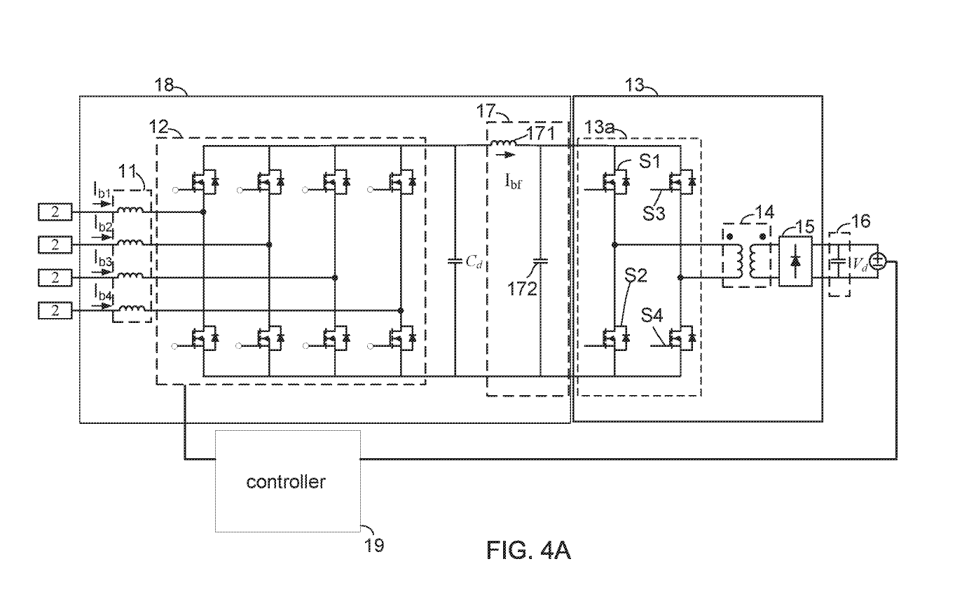

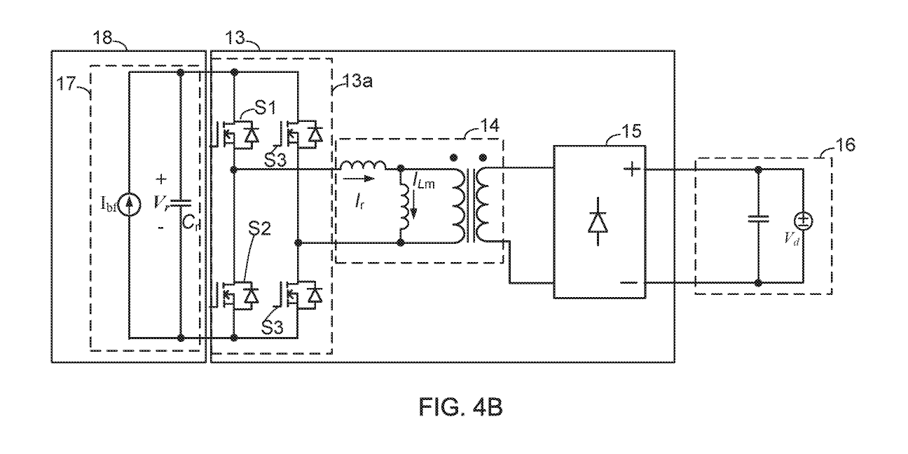

Please referring to FIG. 4A and FIG. 4B, where a solar power converter with isolated bipolar full-bridge resonant circuit architecture diagram and a solar power converter with isolated bipolar full-bridge resonant circuits and other schools circuit architecture diagram. The solar power converter of the present invention has isolated bipolar full-bridge resonant circuit of a solar power converter. As we all know, the solar power converter into isolated and non-isolated, wherein the non-isolated solar power converter comprises a boost converter solar power, solar power buck converter, and buck/boost solar power conversion, and the other, isolated solar power converter includes a push-pull solar power converters and fly-back converters solar power.

referring to FIG. 4A again, solar power converter of the present invention has isolated bipolar full-bridge resonant circuit 1 (hereinafter referred to as solar power converter 1) department comprises: a first stage circuit module 18, a second-stage circuit module 13, and an energy storage unit 16. The first stage shown in FIG. 4A circuit module 18 system comprising: a storage unit 11, and a multiphase interleaved power converter unit 12, wherein, the storage unit 11 is coupled outside a solar module 2 and further from the solar module 2 to obtain a current value, and through the storage unit 11 and coupled to the solar module 2, the multi-phase interleaved power conversion unit 12 through the system while the energy storage unit 11 also coupled to the solar module 2 to receive the current value to the current value into the solar module 2 performs a maximum power point tracking based on the voltage value. This, of special note is that the multi-phase interleaved power conversion unit 12 may be a boost converter, buck converter, a combination of any two of the above.

referring to FIG. 4A and FIG. 4B again, the second-stage circuit module 13 system comprising: a full-bridge resonant converter unit 13a, a transforming unit 14, a rectifying unit 15, and a filter unit 17, wherein, the filter unit 17 has an inductor 171 and a capacitor 172, wherein one end of the inductor 171 is coupled to the multi-phase interleaved power conversion unit 12, and the other end is coupled to the high voltage terminal of the capacitor 172, and the low-side line of the capacitor 172 is coupled to the multiphase interleaved power conversion unit 12; thus, the filter unit 17 by inductor 171 (L_{f}) of the output current of the multiphase interleaved power conversion unit 12 is stored, so that the second-stage circuit module equivalent to the input terminal 13 is coupled to multiphase interleaved power conversion unit 12, one current source I_{bf}, and is the current source I_{bf} the storage capacitor 172, its average voltage Vᵣ is the one generating the multiphase interleaved power conversion unit 12 of output voltage V_{b}.

referring to FIG. 4B again, the Full-bridge resonant converter unit 13a is coupled to the filter unit 17, for receiving the mean voltage Vᵣ, and performs a processing on the average rectified voltage Vᵣ, wherein the transforming unit 14 is coupled to the primary side of the a full-bridge resonant DC converting unit 13a, the secondary side thereof is coupled to the input terminal of the rectifying unit 15, furthermore, the output terminal of the rectifier unit 15 is coupled to the system a filter 16 for generating stable. In the present invention, further includes a controller 19, which coupled to the storage unit 11, the multi-phase interleaved power conversion unit 12, and the filter output terminal of the multiphase interleaved power conversion unit 16 for controlling the multi-phase interleaved power conversion unit 12 of the duty cycle.

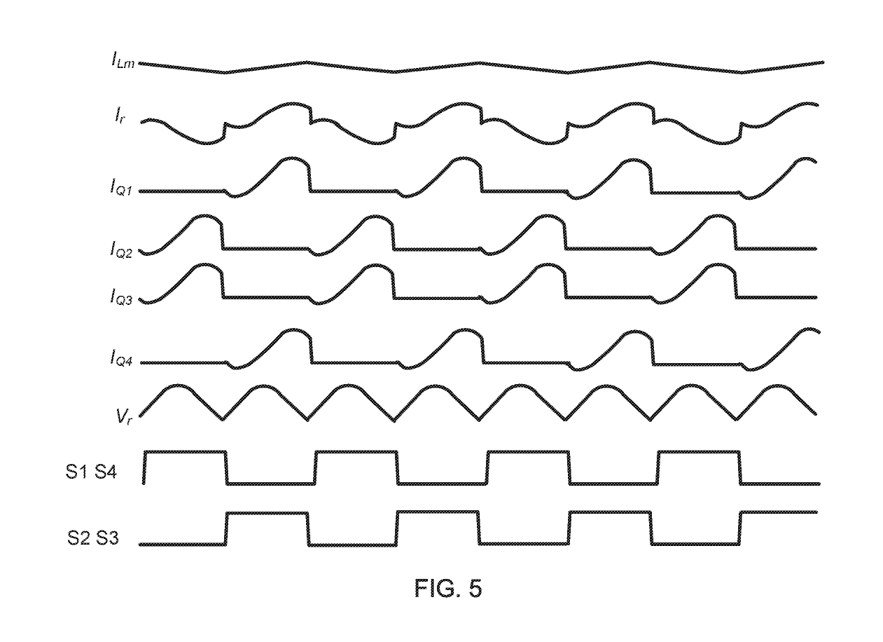

Please referring to FIG. 5, where the solar power converter of the present invention having an isolated two-stage full-bridge resonant circuit simulation wave form. Where the filter unit 17 by inductor 171 (L_{f}) of the output current of the multiphase interleaved power conversion unit 12 is stored, so that the second-stage circuit module 13 equivalent to the input terminal coupled to multiphase interleaved power conversion unit 12, one current source I_{bf}, and is the average voltage Vᵣ of the multiphase interleaved power conversion unit 12 of output voltage V_{b}. In particular, the resonant frequency of the circuit of the full-bridge resonant converter unit 13a is formed of the filtering unit of the resonant capacitor Cᵣ 17 by the one of the transforming unit 14 leakage inductance Lᵣ, and, the transforming unit 14 can be used the turns ratio of the design to be boosted. So, when the full-bridge resonant converter unit 13a of the four switches (S1, S2, S3, S4) phase shift angle of maximum, high efficiency, it can be done without voltage control.

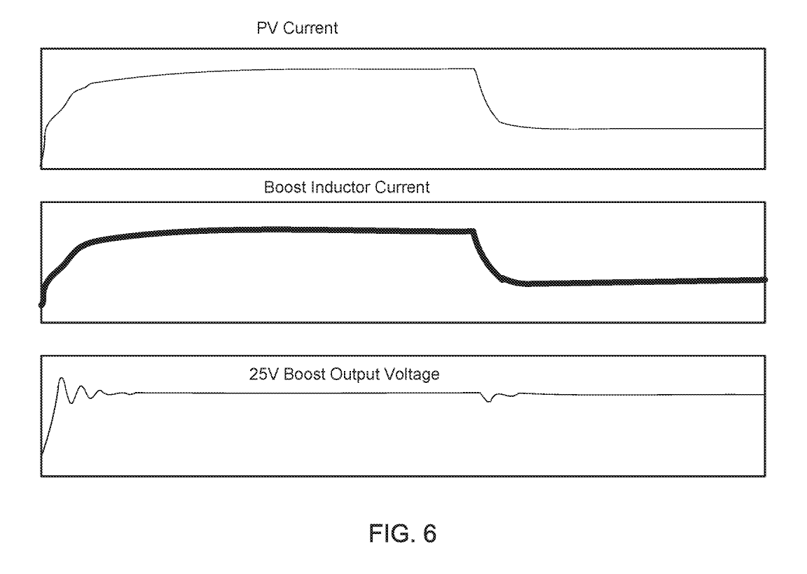

Please referring to FIG. 6, where the PV start and variable load of an analog waveform diagram of the present invention. As shown in FIG. 6, in the embodiment of the present invention, the maximum power point using the input line 19 V, PV 100 W of the multi-phase interleaved power conversion unit 12 of the output is set to 25 V, the battery voltage is set to 24 V. Also, the number of turns of the second-stage circuit module 13 ratio of about 1, the first stage 18 of the multi-phase circuit module interleaved power conversion unit 12 and the second-stage circuit module 13 of the full-bridge resonant converter unit 13a switching frequency are set to 100 kHz. In the embodiment of the present invention, by coupled a CL filter (filter unit) in the first stage 18 of the circuit module inputs multiphase interleaved power conversion unit 12 to reduce the PV of the current ripple. The current command input also add a 1 kHz low-pass filter cut-off frequency for making the multi-phase interleaved power conversion unit 12 of a smooth start. The second stage of the full-bridge resonant converter module unit 13a of the fixed phase shift uncontrolled manner, with its turns ratio to maintain the output voltage of 25 V, and the resonance frequency is set at 160 kHz, Cᵣ of 20 μF, leakage inductance Lᵣ to 0.05 μH, self-inductance of the transformer 8 μH, its low self-inductance, it helps reduce the volume of the transformer.

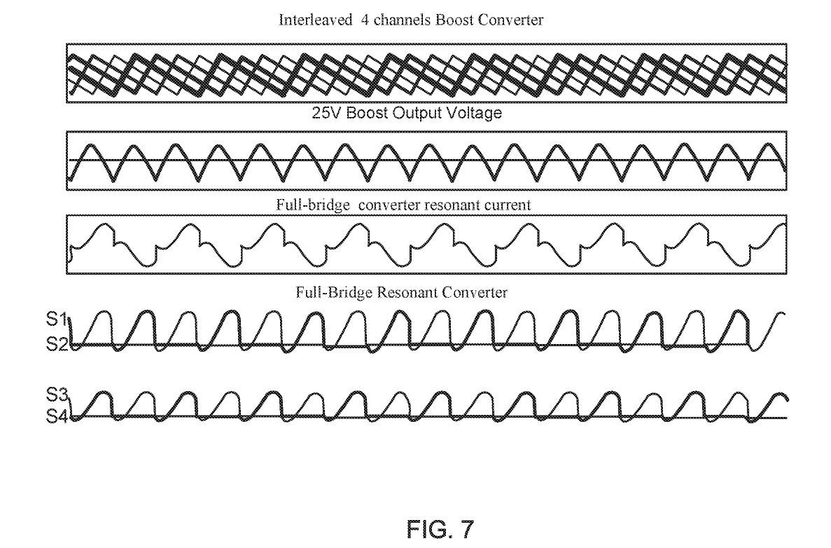

Please referring to FIG. 7, whereat full load simulation waveform diagram of each part of the isolated bipolar full-bridge resonant converter solar power of the present invention. As shown in FIG. 7, in the embodiment of the present invention, the multi-phase interleaved power conversion unit 12 of the first stage of the circuit module 18, where inductance and current are interleaved in four-phase. Moreover, the full-bridge resonant converter unit of the four power switch (S1, S2, S3, S4) 13a can also reach the zero-voltage switching, bypass diode's power switch has zero current turn-on and off.

In summary, depicted in FIG. 6 and FIG. 7 shows the simulation waveform diagram exemplary only examples, not intended to limit the interleaved multiphase switching frequency of the power conversion unit 12 connection. In addition, the isolated two-stage solar power converter circuit architecture frequently used among the filtering unit, and other circuit elements can also be combined with a simple way to expand into the circuit architecture of the present invention being.

Therefore, through above descriptions, the solar power converter with isolated bipolar full-bridge resonant circuit provided by the present invention has been introduced completely and clearly; in summary, the present invention includes the advantages of:

(1) Different from the conventional two-stage isolation solar power converter to be controlled of the frequency of half-bridge resonant circuit to achieve maximum conversion efficiency, the present invention is the addition of a further full-bridge resonant converter unit in a solar power converter being, by fixed uncontrolled phase shift full-bridge resonant converter mode control unit; so designed, full-bridge resonant converter power unit of the switch at all under any load can reach the zero voltage switching, not only can improve efficiency at light loads, the whole the range of variation of load efficiency were improved and useful.

In addition, because this full-bridge resonant converter unit of the resonant transformer inductance value is quite low, would be more solar power converter in an isolated two-stage architecture, which can use the smaller of the transformer, to help reduce costs and reduce the volume.

The above description is made on embodiments of the present invention. However, the embodiments are not intended to limit scope of the present invention, and all equivalent implementations or alterations within the spirit of the present invention still fall within the scope of the present invention.

1. A solar power converter with isolated bipolar full-bridge resonant circuit, comprising:
a storage unit, comprising four energy storing inductors and being coupled to a solar module for storing an electrical power outputted by the solar module;
a multiphase interleaved power converter unit, being coupled to the four energy storing inductors of the storage unit by four switch arm sets thereof; wherein each of the four switch arm sets comprises an upper switch arm and a lower switch arm;
a filter unit, comprising an inductor and a capacitor, wherein one end of the inductor is coupled to the four upper switch arms; moreover, one end of the capacitor is coupled to the other end of the inductor, and the other end of the capacitor is coupled to the four lower switch arms;
a full-bridge converter unit, comprising four MOS switches having one body diode; wherein a first MOS switch and a third MOS switch of the four MOS switches are coupled to the filter unit by the drain terminal thereof, and a second MOS switch and a fourth MOS switch of the four MOS switches being coupled to the filter unit by the source terminal thereof;
a transforming unit, being coupled to the full-bridge converter unit wherein the first MOS switch and the third MOS switch of the four MOS switches are coupled to the transforming unit by the source terminal thereof, and the second MOS switch and the fourth MOS switch of the four MOS switches being coupled to the transforming unit by the drain terminal thereof; and
a rectifier unit, being coupled to the transforming unit.

2.-6. (canceled)
